(19) United States
(12) Patent Application Publication
(10) Pub. No.: US 2010/0262678 A1
(43) Pub. Date: Oct. 14, 2010

(54) CONFIGURATION OF A SINGLE-PURPOSE APPLICATION VIA A WEB APPLICATION

(75) Inventors: Timothy R. Morgan, Boise, ID (US); Scott W. Bishel, Redmond, WA (US); Wade C. Dorrell, Boise, ID (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/422,316

(22) Filed: Apr. 13, 2009

(51) Int. Cl. G06F 15/177; G06F 3/048

(52) U.S. Cl. 709/220; 715/764

(57) ABSTRACT

Architecture for providing easy and convenient configuration of a single-purpose application (SPA). A web-based SPA is retained on a client device for viewing specific information provided from a web server. A web-based identification component obtains an identity associated with the client device or device user. A website user interface enables the user to enter configuration information of the SPA. Subsequently, the configured SPA receives the requested information from the web server based on the identity. A storage component stores the configuration information on a remote web server and/or the client device for backup purposes. A communications component refreshes the requested information to provide updated information to the user via the SPA.

### BACKGROUND

A single-purpose application (SPA) is an interactive software component that provides a specific service to a user or other consumer. An SPA can display to the user various types of information, such as news headlines, local temperature and weather conditions, the current time, and a calendar, for example. Typical SPAs retrieve the aforementioned types of information from feeds available from a viewable website or other web-based service. SPAs present the information to the user in a compact and easy-to-understand interface.

SPAs are occasionally referred to as “widgets” or “gadgets” and can reside on a desktop or sidebar of a client device (e.g., a personal computer or the like) or can appear within a web page displayed on a web browser, or in another HTML-based interactive environment. Proprietary SPAs can be produced by web-based service providers or software producers, and can be used to promote a company products and/or services. SPAs thus provide users with ease of access to useful information such as key performance indicators, and the like.

Typically, SPAs are manually configured by the user to point to a selected resource on the Internet from which the SPA retrieves data. For example, if a user chooses to use a “company stock” SPA to monitor the price of a particular company stock, the user can interact with a settings or configuration dialog that enables the new stock to be added to the SPA. The company stock symbol is typed into a text box. If the user does not know the specific stock symbol, the user can type in the company name, initiate a search, and select the company from the results.

The aforementioned procedure entails several user-initiated steps that prompt specific proactive efforts from the user in order to configure a stock-oriented SPA. This can be inconvenient and inefficient for a user when certain information is not readily available. Similar problems can be encountered with configuring other types of SPAs.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for facilitating configuration of a single-purpose application (SPA). Instead of a complex manual configuration process, the user accesses a web page associated with the SPA where the user is presented with a menu selection of buttons or check boxes corresponding to various configuration settings or parameters (e.g., one or more particular stocks to be tracked). The user enters an identification at the website. Upon making one or more selections from the menu selection on the associated web page, the configuration settings corresponding to the selections are automatically added to the SPA. In this way, close integration is provided between the SPA and the associated website, allowing a simplified arrangement for the user to configure the SPA.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented system for performing configuration.

FIG. 2 illustrates updating and hosting components used with the system for performing configuration.

FIG. 3 illustrates an alternative embodiment of a system for performing configuration of an SPA.

FIG. 4 illustrates an alternative embodiment of the system for performing configuration of an SPA.

FIG. 5 illustrates a diagram having refresh and host functionality as used with a system for SPA configuration.

FIG. 6 illustrates a diagram having a storage component for storing configuration information.

FIG. 7 illustrates a diagram where the user interface component employs components for entering identity and configuration information.

FIG. 8 illustrates a method of configuration.

FIG. 9 illustrates further aspects in the method of configuration.

FIG. 10 illustrates data flow for the method and system of configuration.

FIG. 11 illustrates a block diagram of a computing system operable to execute SPA configuration in accordance with the disclosed architecture.

FIG. 12 illustrates an exemplary computing environment operable to provide SPA configuration.

### DETAILED DESCRIPTION

The disclosed architecture provides users with an easy and convenient interface for configuring a single-purpose application (SPA). An identification component is provided that obtains an identity associated with a user operating a client device. An SPA is retained on the client device that receives information for display from a website. The SPA receives requested information from a web service. A user interface (UI) is incorporated into the website for enabling the user to enter configuration information of the SPA. Subsequently, the configured SPA receives the requested information from the web service based on the identity associated with the user.

The architecture finds particular applicability to enterprise performance monitoring and management. For example, SPAs can be configured to access corporate KPI (key performance indicator) data such as accounts, finances, sales, etc., via UI elements such as menus and other web page features for quick selection and setup of the SPAs, for example.

The architecture can include a storage component for storing the SPA configuration information at a remote location (e.g., web server and/or client device). In this manner, the configuration information can be saved locally or remotely, and can thereby be backed up to assist the user in the event of a problem with the SPA or the client device. A communications component can also be employed for refreshing the requested information to the SPA from the web service. In this fashion, the requested information (e.g., a stock, a weather update, or news-related item) can be periodically updated to provide the user with the latest information.

The identification component can include login and password entry fields on the user interface component of the website. Additionally, the UI can include a score card interface for providing multiple configuration selections. A web server can be used for hosting the website and providing the web service to the SPA. The client device can be any suitable device, such as a desktop or portable computer, including a handheld computing device or a cell phone, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

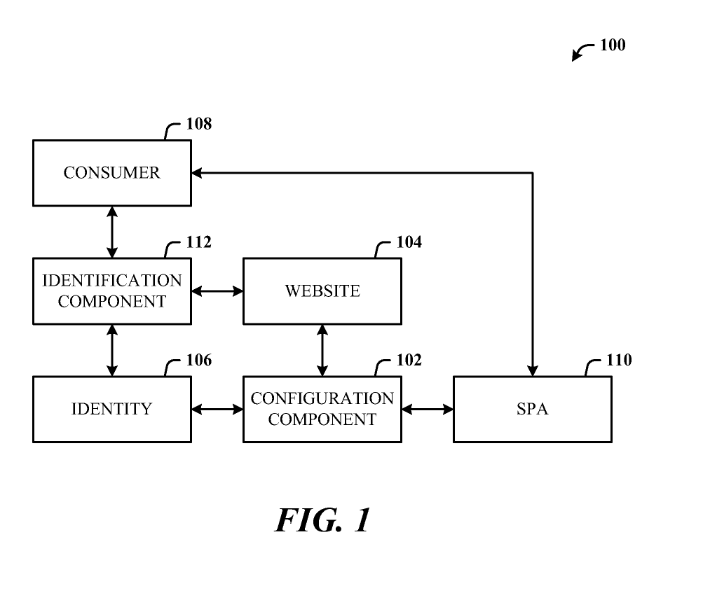

FIG. 1 illustrates a computer-implemented system 100 for performing configuration of an SPA. The system 100 includes a configuration component 102 as part of a website 104. The configuration component 102 automatically utilizes an identity 106 of a consumer 108 to configure a web-based SPA 110 for utilization by the consumer 108. An identification component 112 is also included in the website 104 that obtains the identity 106 of the consumer 108 seeking utilization of the SPA 110, in order to configure the SPA 110.

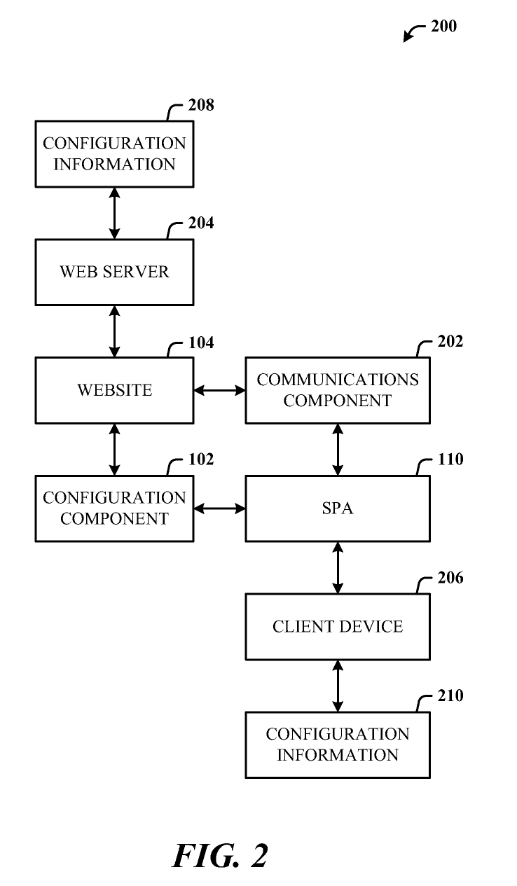

FIG. 2 illustrates an alternative embodiment of a system 200 for performing configuration of an SPA 110. A communications component 202 communicates updated information from the website 104 to the SPA 110 (of FIG. 1). In this manner, upon configuration, the SPA 110 is periodically updated to display current information. The communications component 202 can be programmed to access the website 104 at regular periodic intervals to refresh the SPA 110 as new values of information become available. The communications component 202 can be a module of the SPA 110, or can be a discrete component separate from the SPA 110.

As also illustrated in FIG. 2, a web server 204 is provided for hosting the website 104. The identification component 112 of FIG. 1 can also be associated with the website 104 for identification processing. The web server 204 provides the information presented by the SPA 110. A client device 206 hosts the SPA 110. The client device 206 can be a desktop computer, portable computer, a handheld device, a cell phone, or other suitable devices, for example.

The SPA 110 includes configuration information 208 that incorporates the settings of the SPA 110. The configuration information 208 can be a portion of HTML or javascript that includes a URL (uniform resource locator) pointing to a source for data to be presented in the SPA 110. As illustrated in FIG. 2, configuration information 208 of the SPA 110 can be stored on the web server 204. In this manner, the configuration information 208 can be retained remotely from the SPA 110. Alternatively, configuration information 210 can be stored on the client device 206. In this manner, the configuration information (208, 210) can be retained locally with the SPA 110. Additionally, the configuration information (208, 210) can be retained remotely on the web server 204 and locally on the client device 206 to provide a backup in the event of a loss of data.

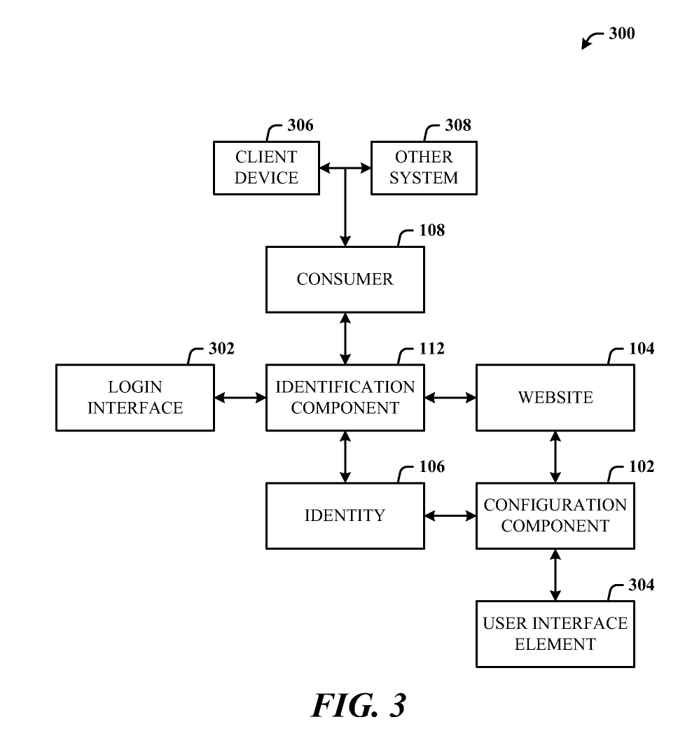

FIG. 3 illustrates an alternative embodiment of a system 300 for performing configuration of an SPA. The identification component 112 (of FIG. 1) further comprises a login interface 302 of the website 104. The login interface 302 can include text fields for enabling the user to enter a login/password combination. However, in another aspect, the identification component 112 can accept any suitable identifying information, including a telephone number or a PIN (personal identification number) or any suitable alphanumerical string that serves to identify a consumer 108 or consumer device to the system 100.

As also illustrated in FIG. 3, the configuration component 102 (of FIG. 1) includes a user interface element 304 of the website 104. The user interface element 304 can be any suitable interface for enabling a selection of a configuration element. The user interface element 304 can be a suitable website link that includes a code for configuring the SPA 110. In one aspect, the user interface element 304 includes a “score card” viewable on the website 104. The score card can be a grid of information where each cell can represent an individual piece of information. The user can select a button or check box on a desired cell within the score card that represents a piece of information that can be added to the SPA 110. Each cell includes a code segment (e.g., in HTML, javascript, CSS (cascading style sheet), or the like) that points to a resource on the website 104, or alternatively, a backend web service used by the website 104.

In another aspect, the user interface element 304 can include a drop down menu displayed on the website 104. One or more selection items on the drop down menu can include information to add to the SPA 110 (e.g., a specific stock to be tracked). The SPA 110 automatically pulls in configuration information to monitor that information of the menu. It is to be appreciated that the SPA 110 and the website 104 can be co-authored to work cooperatively.

As also illustrated in FIG. 3, the consumer 108 can be a client device 306 and/or other system 308. The client device 306 can be any type of desktop or portable computing device, including a handheld device, a cell phone, or the like.

As described herein, the system 100 provides ease-of-use for the user when adding information to an SPA 110, particularly when the addition of information is a multi-step process performed through a typical configuration interface. This ease-of-use is achieved through functionality of the website 104 created for integration with a particular SPA 110 and having configuration information that can be stored on the client device 306, instead of or in addition to storing the configuration information on a web server.

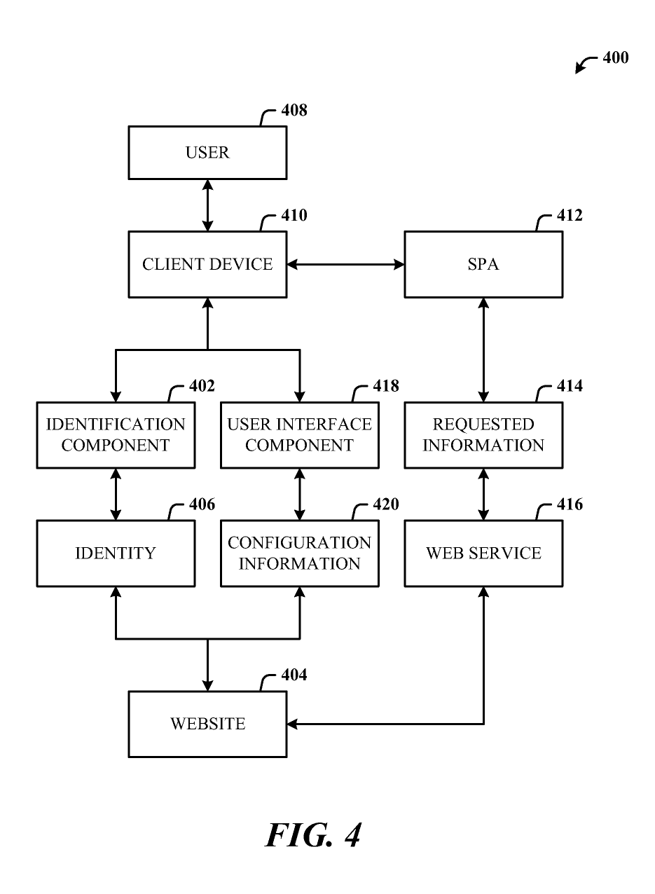

FIG. 4 illustrates an alternative embodiment of a system 400 for performing configuration of an SPA. An identification component 402 of a website 404 is provided (similar to the identification component 112 of FIG. 1). The identification component 402 obtains an identity 406 associated with a user 408 operating a client device 410 or the client device 410 itself. The identity 406 can be represented by any suitable identification indicia, such as a name or number associated with the user 408. As mentioned hereinabove, the client device 410 can be a desktop computing device or a portable computing device. For example, the client device 410 can be a PDA (personal digital assistant) or a cell phone or any other suitable handheld device having a range of functionality for accessing and interacting with web pages.

As also illustrated in FIG. 4, the system 400 includes a web-based SPA 412 (similar to the SPA 110 of FIG. 1). The SPA 412 resides on the client device 410 and receives requested information 414 from a web service 416 associated with the website 404. The requested information 414 can be related to news, weather, or stocks, for example, and can be any other type of information for which a user 408 desires to obtain currently updated status. A user interface component 418 is included on the website 404 to enable the user 408 to enter configuration information 420 of the SPA 412, which enables the SPA 412 to receive the requested information 414 to the SPA 412 from the web service 416 based on the identity 406 associated with the user 408.

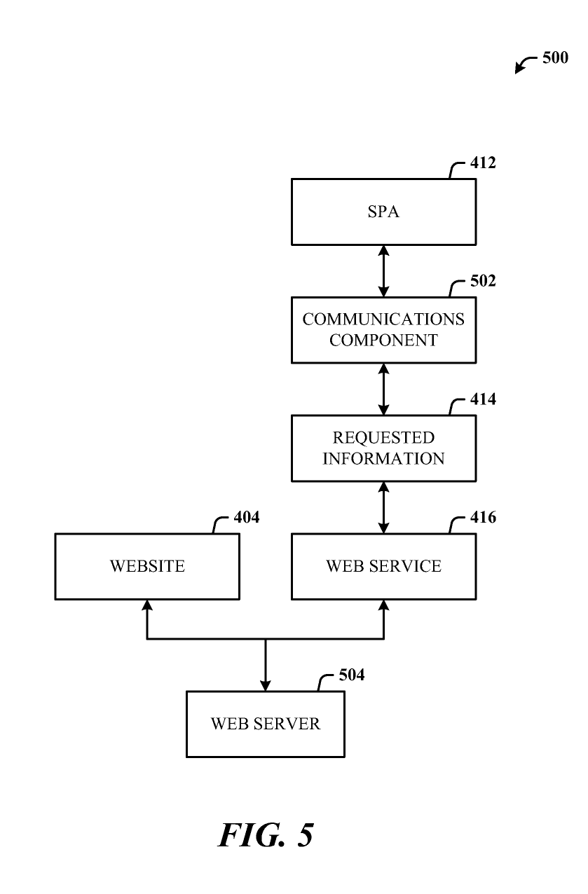

FIG. 5 illustrates a diagram 500 having refresh and host functionality as used with the system 400 for SPA configuration. A communications component 502 refreshes the requested information 414 (of FIG. 4) to the SPA 412 from the web service 416. The communications component 502 can be configured to receive a feed of the requested information 414 pushed in from the web service 416. Alternatively, the communications component 502 can actively pull in the latest version of the requested information 414 from the web service 416. The web service 416 can be a background feed from a web server 504. The web server 504 hosts the website 404 and provides the web service 416 to the SPA 412.

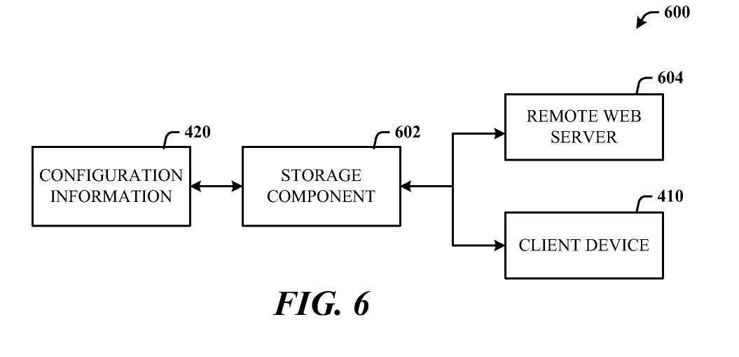

FIG. 6 illustrates a diagram 600 having a storage component 602 for storing configuration information 420. The configuration information 420 can be a segment of code (e.g., HTML, javascript, etc.) that is copied and saved into the storage component 602 (e.g., a database) upon activating the user interface component 418. The storage component 602 can store the configuration information 420 on a remote web server 604, which can be the server that hosts the website 404. Alternatively, the storage component 602 can store the configuration information 420 on the client device 410, as part of the SPA 412 or in another location accessible by the SPA 412. The storage component 602 can also store the configuration information 420 on both the remote web server 604 and the client device 410, to provide a backup in the event of a data loss or offline events that can occur on either the server 604 or the client device 410.

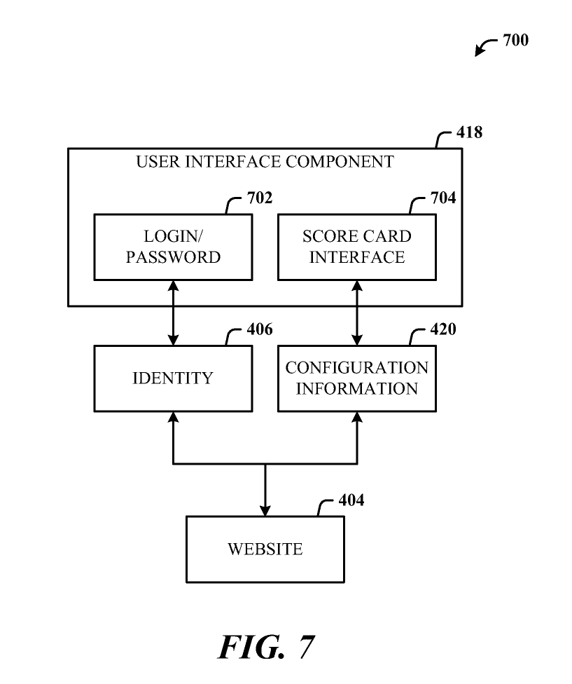

FIG. 7 illustrates a diagram 700 where the user interface component 418 employs components for entering identity and configuration information. The user interface component 418 (similar to the user interface element 304 of FIG. 3) can be an interactive portion displayed on the website 404 and can include one or more interactive elements that can be selected and used for input by the user 408. As illustrated, the identification component 402 (of FIG. 4) can be represented by one or more login/password entry fields 702 on the user interface component 418. The login/password entry fields 702 can include text fields for enabling the user to enter a login/password combination. However, as with the aforementioned embodiments, any suitable identifying information can be accepted, including a telephone number, a PIN, or any suitable alphanumerical code that serves to identify a consumer 108 to the system 100.

As illustrated in FIG. 7, the user interface component 418 can include a score card interface 704 for providing multiple configuration selections. The score card interface 704 can be a grid of information where each cell can represent an individual piece of information such as financial data, sales data, accounts data, for example. One or more cells can prompt the user 408 to add a particular piece of information to the SPA. The user 408 can click on a desired cell within the score card to select a piece of information that can be added to the SPA 412. Each cell includes a code segment and/or a suitable website link that includes a code for configuring the SPA 412 and points to a resource on the website 404, or alternatively, the backend web service 416 associated with the website 404. Selecting the desired cell will then copy and save the code segment as described hereinabove. However, any suitable scheme in addition to the score card interface 704 can be employed for enabling selection of a configuration element.

As described herein, the SPA can be implemented using web technologies and also make use of any suitable APIs available in a system namespace dedicated to SPAs. In order to implement an SPA in accordance with the herein disclosed embodiments, a related website includes the ability to uniquely identify the user and/or the user device. The website has a web service available for communication with the SPA. The SPA is able to utilize a URL to a web service associated with the website and the identity of the user, which is the same identity that the website uses. This can be performed automatically via an operating system authentication procedure performed on the website. The SPA “refreshes” itself at pre-defined intervals. These intervals can optionally be configurable by the user. The SPA can also provide the user with the ability to manually initiate a refresh at any time.

In addition to the aforementioned, the user abides with certain prerequisites in order to implement an SPA in accordance with the herein disclosed embodiments. A user downloads and installs the SPA from the website and completes initial configuration. These include selecting the URL to the website, entering the user ID (which can be automatic under an operating system authentication procedure), and optionally, establishing a refresh interval for the SPA.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

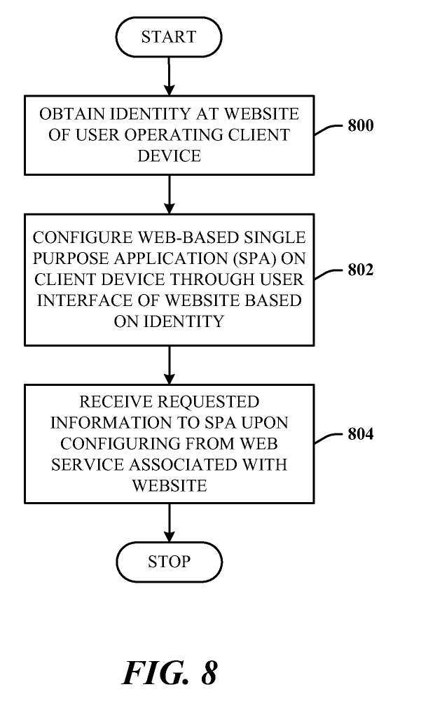

FIG. 8 illustrates a method of configuration. At 800, an identity is obtained at a website of a user operating a client device. At 802, a web-based SPA is configured on the client device through a user interface of the website based on the identity. At 804, requested information is received to the SPA upon configuring from a web service associated with the website. In this manner, the SPA is configured automatically for the user without the additional steps and inconvenience encountered used in the typical manual procedure.

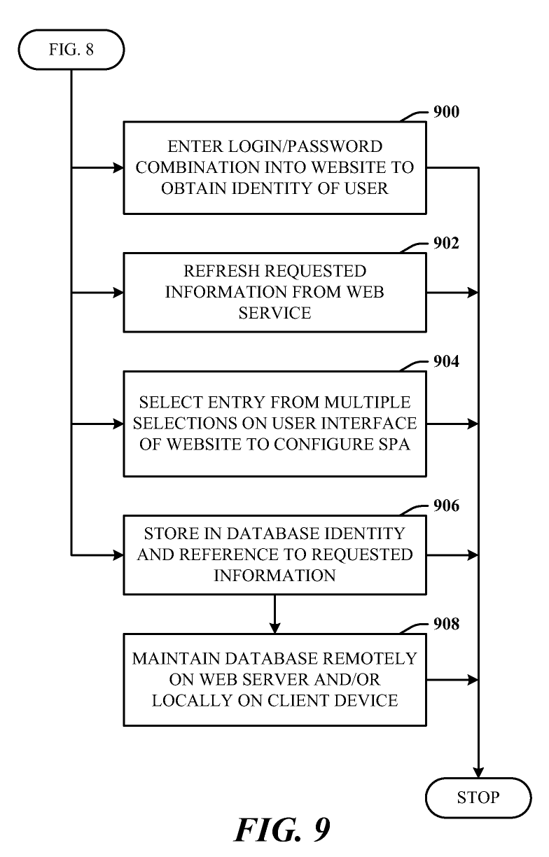

FIG. 9 illustrates further aspects in the method of configuration. At 900, a login/password combination is entered into the website to obtain the identity of the user. At 902, the requested information is refreshed from the web service. At 904, one or more entries are selected from multiple selections on the user interface of the website to configure the SPA. At 906, the identity and a reference to the requested information are stored in a database. At 908, the database is maintained remotely on a web server and/or locally on the client device.

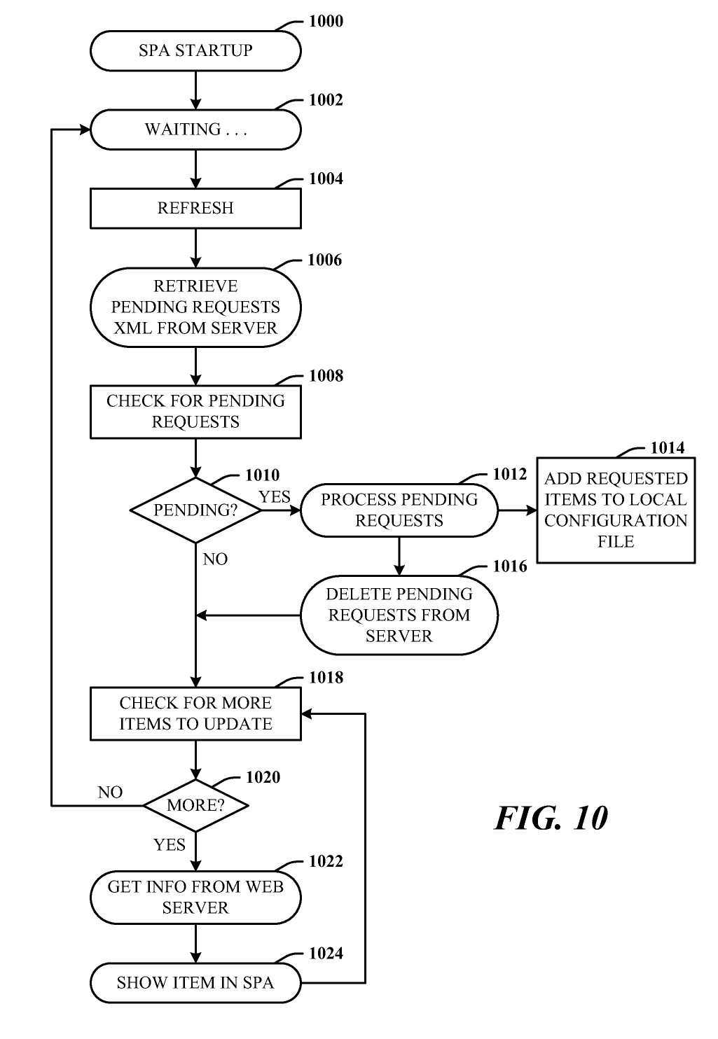

FIG. 10 illustrates data flow for the method and system of configuration. At 1000, the SPA is initially started. Outside the system flow, the user logs into the website. The user views information on the website and chooses a piece of information to monitor in the SPA. A user interface element is selected to add the piece of information to the SPA. The system adds an entry into a database that indicates the user has requested this information. The information includes a user ID and a reference that uniquely identifies the piece of information to add to the SPA.

At 1002, the system waits for input. At 1004, upon performing a “refresh” operation (automatically, because a refresh interval expired, or manually, as initiated by the user), the SPA calls the web service on the website and requests the indicated information. At 1006, the server returns any pending request entries indicated in the database (which can be XML documents). At 1008, the SPA checks for pending requests. If yes, flow is from 1010 to 1012, where the SPA processes the pending requests, and the SPA adds the pending requests into the local configuration file, at 1014, using an available API (e.g., a system.SPA.settings API). From 1012, flow can be to 1016, where the pending request entries in the server database are deleted. Thereafter, flow resumes from 1010 as if no pending requests exist.

At 1018, a check is made by the SPA of its local configuration file to determine if there are more items to update. If no, flow returns from 1020 to the waiting state, at 1002. If yes, flow is from 1020 to 1022, where the SPA refreshes an item of information that is being displayed by getting the latest information from the web server for an item to be displayed by the SPA. At 1024, a new item is displayed in the SPA. Flow returns back to 1018 to check for more items to update, until each item of information is refreshed, including new items. The actions associated with steps 1006, 1016 and 1022 can be web service calls.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

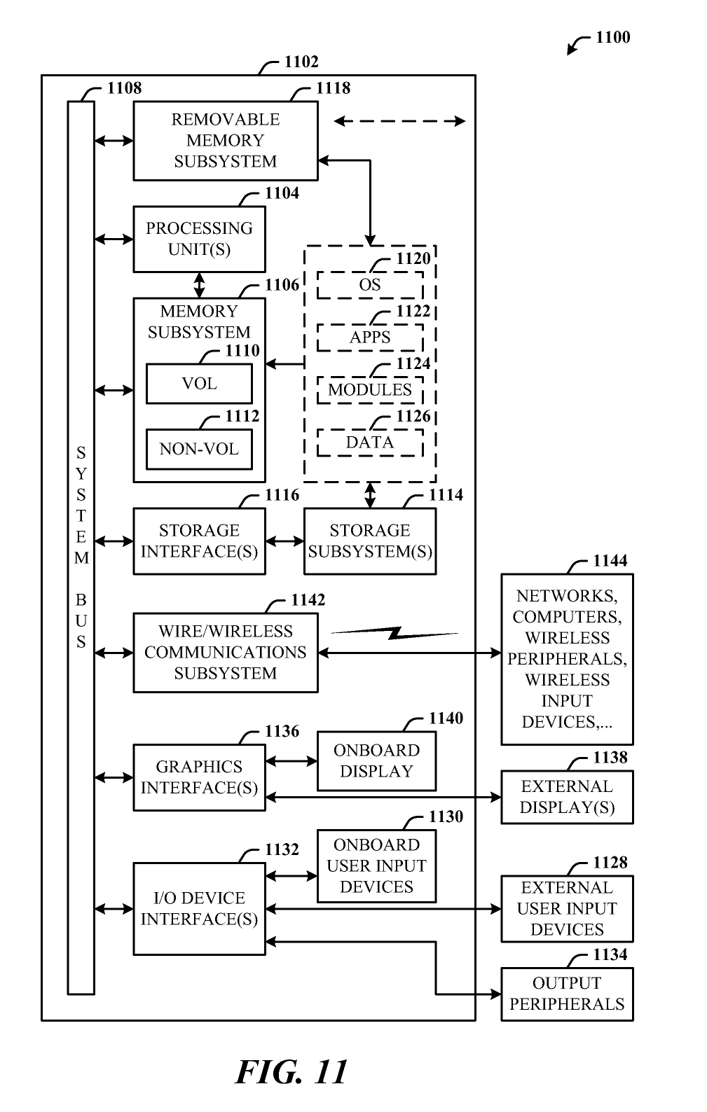

Referring now to FIG. 11, there is illustrated a block diagram of a computing system 1100 operable to execute configuration in accordance with the disclosed architecture. In order to provide additional context for various aspects thereof, FIG. 11 and the following discussion are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the memory subsystem 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes storage subsystem(s) 1114 and storage interface(s) 1116 for interfacing the storage subsystem(s) 1114 to the system bus 1108 and other desired computer components. The storage subsystem(s) 1114 can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The aforementioned application programs 1122, program modules 1124, and program data 1126 can include the computer-implemented configuration system 100 of FIG. 1, to include the configuration component 102, the website 104, the identity 106, the consumer 108, the website-based single purpose application 110, and the identification component 112 of FIG. 1, the updating and hosting components 200 including the communications component 202, the web server 204, the client device 206, the configuration information 208, and the configuration information 210 of FIG. 2, the interface and consumer components 300 including the login interface 302, the user interface element 304, the client device 306, and the other system 308 of FIG. 3.

The aforementioned application programs 1122, program modules 1124, and program data 1126 can include the computer-implemented configuration system 400 of FIG. 4, to include the identification component 402, the website 404, the identity 406, the user 408, the client device 410, the website-based single purpose application 412, the requested information 414, the web service 416, the user interface component 418, and the configuration information 420 of FIG. 4, the refreshing and hosting components 500 including the communications component 502 and the web server 504 of FIG. 5, the implementations 600 including the storing component 602 and the remote web server 604 of FIG. 6, features 700 including the login/password entry fields 702 and the score card interface 704 of FIG. 7.

The aforementioned application programs 1122, program modules 1124, and program data 1126 can also include the flow diagram and entities of FIG. 10, and the methods of FIGS. 8 and 9, for example.

The storage subsystem(s) 1114 and memory subsystems (1106 and 1118) serve as computer readable media for volatile and non-volatile storage of data, data structures, computer-executable instructions, and so forth. Computer readable media can be any available media that can be accessed by the computer 1102 and includes volatile and non-volatile media, removable and non-removable media. For the computer 1102, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP) using logical connections via a wired/wireless communications subsystem 1142 to one or more networks and/or other computers. The other computers can include workstations, servers, routers, personal computers, microprocessor-based entertainment appliance, a peer device or other common network node, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or has other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10 BaseT wire Ethernet networks used in many offices.

The illustrated aspects can also be practiced in distributed computing environments where certain tasks are performed by remote processing devices that are linked through a communications network. In a distributed computing environment, program modules can be located in local and/or remote storage and/or memory system.

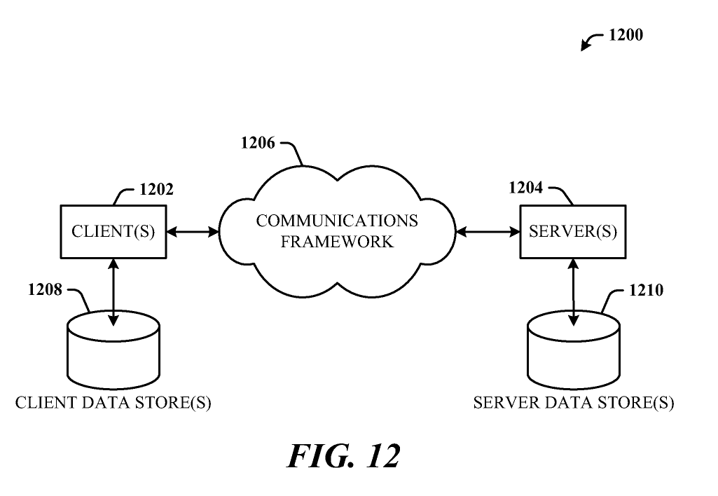

Referring now to FIG. 12, there is illustrated a schematic block diagram of a computing environment 1200 that can be used for configuration. The environment 1200 includes one or more client(s) 1202. The client(s) 1202 can be hardware and/or software (e.g., threads, processes, computing devices). The client(s) 1202 can house cookie(s) and/or associated contextual information, for example.

The environment 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The environment 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented configuration system, comprising:
a configuration component of a website for automatically utilizing an identity of a consumer to configure a web-based single-purpose application (SPA) for utilization by the consumer; and
an identification component of the website for obtaining the identity of the consumer seeking utilization of the SPA.

2. The system of claim 1, further comprising a communications component for communicating updated information from the website to the SPA.

3. The system of claim 1, further comprising a web server for hosting the website and a client device for hosting the SPA.

4. The system of claim 1, further comprising configuration information of the SPA stored on at least one of a web server or a client device.

5. The system of claim 1, wherein the identification component further comprises a login interface of the website.

6. The system of claim 1, wherein the configuration component further comprises a user interface element of the website.

7. The system of claim 1, wherein the consumer further comprises at least one of a client device or another system.

8. A computer-implemented configuration system, comprising:
an identification component of a website for obtaining an identity associated with a user operating a client device;
a web-based SPA of the client device for receiving requested information from a web service associated with the website; and
a user interface component of the website for enabling the user to enter configuration information of the SPA for receiving the requested information to the SPA from the web service based on the identity.

9. The system of claim 8, further comprising a communications component for refreshing the requested information to the SPA from the web service.

10. The system of claim 8, further comprising a web server for hosting the website and providing the web service to the SPA.

11. The system of claim 8, further comprising a storage component for storing the configuration information on at least one of a remote web server or the client device.

12. The system of claim 8, wherein the identification component further comprises login/password entry fields on the user interface component of the website.

13. The system of claim 8, wherein the user interface component further comprises a score card interface for providing multiple configuration selections.

14. The system of claim 8, wherein the client device is one of a computing device or a handheld device.

15. A computer-implemented method of configuration, comprising:
obtaining an identity at a website of a user operating a client device;
configuring a web-based SPA on the client device through a user interface of the website based on the identity; and
receiving requested information to the SPA upon configuring from a web service associated with the website.

16. The method of claim 15, further comprising entering a login/password combination into the website to obtain the identity of the user.

17. The method of claim 15, further comprising refreshing the requested information from the web service.

18. The method of claim 15, further comprising selecting at least one entry from multiple selections on the user interface of the website to configure the SPA.

19. The method of claim 15, further comprising storing in a database the identity and a reference to the requested information.

20. The method of claim 19, further comprising maintaining the database at least one of remotely on a web server or locally on the client device.
